(19) United States
(12) Patent Application Publication
(10) Pub. No.: US 2014/0159285 A1
(43) Pub. Date: Jun. 12, 2014

(54) COMPOSITION FOR LASER DIRECT STRUCTURING AND LASER DIRECT STRUCTURING METHOD USING SAME

(71) Applicant: Kwan Soo Choi, Gyeonggi-do (KR)

(72) Inventor: Kwan Soo Choi, Gyeonggi-do (KR)

(73) Assignee: DIGITAL GRAPHICS INCORPORATION, Gyeonggi-do (KR)

(21) Appl. No.: 14/115,473

(22) PCT Filed: May 27, 2011
(86) PCT No.: PCT/KR2011/003931

§ 371 Date: Nov. 4, 2013

(30) Foreign Application Priority Data
May 3, 2011 (KR) 10-2011-0041882
May 6, 2011 (KR) 10-2011-0043199

(51) Int. Cl. B29C 67/00; C08K 3/22; C08K 11/00

(52) U.S. Cl. CPC B29C 67/0051; C08K 11/00; C08K 3/22
USPC 264/401; 524/80; 524/430

(57) ABSTRACT

In an embodiment of the present invention, a touch screen is provided, the touch screen characterized by: an indium tin oxide (ITO) film deposited on a top surface of a flexible plastic film; a first metal layer deposited on the ITO film, and a second metal layer plated on the first metal layer. According to the embodiment of the present invention, the touch screen and the method of manufacturing the same having the excellent sensitivity while securing durability may be provided.

### TECHNICAL FIELD

The present invention relates to a touch screen and a method of manufacturing the same.

### BACKGROUND ART

A touch screen is a device that may detect the approach or touched positions of fingers or a touch pen. The touch screen is mounted on a screen of a video display device so as to be able to easily input information.

The touch screen uses a transparent electrode to detect a touch input by fingers or a pen. The transparent electrode may be formed by disposing a metal layer on a transparent conductive oxide film such as indium tin oxide (ITO).

However, when the metal layer is directly formed on the ITO film, the adhesion of the metal layer is degraded to degrade durability and increase the resistance of the surface of the ITO, thereby degrading the sensitivity of the touch screen.

### DISCLOSURE OF INVENTION

An embodiment of the present invention is to provide a touch screen having excellent sensitivity while securing durability and a method of manufacturing the same.

In an embodiment of the present invention, a touch screen is provided, the touch screen comprising: an indium tin oxide (ITO) film deposited on a top surface of a flexible plastic film; a first metal layer deposited on the ITO film; and a second metal layer plated on the first metal layer.

In another embodiment of the present invention, a method of manufacturing a touch screen is provided, the method comprising: heat-treating an ITO film from to prevent the shrinkage thereof; removing and pre-processing impurities on a surface of the ITO film; depositing a first metal layer on the pre-processed ITO film; depositing a second metal layer on the firs metal layer; and plating a third metal layer on the second metal layer.

### ADVANTAGEOUS EFFECTS

According to the embodiment of the present invention, the touch screen having the excellent sensitivity while securing durability may be provided and the method of manufacturing the same.

### BRIEF DESCRIPTION OF DRAWINGS

The above and other objects and features of the present invention will become apparent from the following description of preferred embodiments taken in conjunction with the accompanying drawings.

FIG. 1 is a cross-sectional view of a touch screen according to a first embodiment of the present invention;

FIG. 2 is a cross-sectional view of a touch screen according to a second embodiment of the present invention; and

FIG. 3 is a flow chart of a method of manufacturing a touch screen according to an embodiment of the present invention.

### DETAILED DESCRIPTION

Hereinafter, a touch screen and a method of manufacturing the same according to an embodiment of the present invention will be described in detail with reference to the accompanying drawings. However, if it is determined that the detail description of relevant known functions or components makes subject matters of the present invention obscure, the detailed description thereof will be omitted.

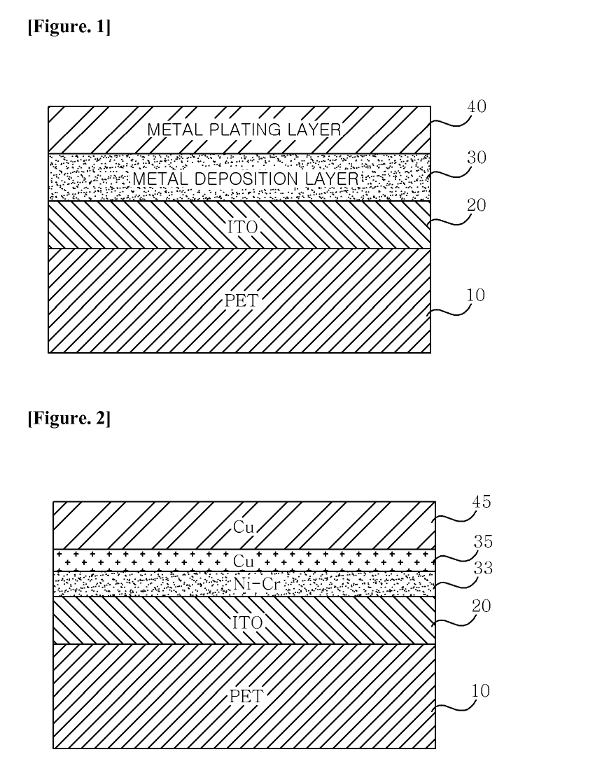

FIG. 1 is a cross-sectional view of a touch screen according to a first embodiment of the present invention.

As shown in FIG. 1, the touch screen according to the first embodiment of the present invention includes a transparent conductive film 20 such as indium tin oxide, or the like, that is deposited on a top surface of the flexible plastic film 10 and a metal layer 30 and a metal plating layer 40 that are deposited on a transparent conductive film 20.

The flexible plastic film 10 may use a film made of PES, PC, PE, PI, Acryl, or the like. The embodiment of the present invention illustrates a case in which a polyethylene terephthalate (PET) film 10 is used.

In this case, the PET film 10 has shrinkage characteristics in a range of 100 to 150.When the PET film 10 on which the transparent conductive film 20 is deposited is used to manufacture the touch screen, there is a problem in that an align is mismatched due to the shrinkage of the PET film 10 at the time of performing heat treatment for a bonding process of upper and lower plates. Therefore, the shrinkage that may occur during a metal layer deposition process and a post-process may be prevented by performing an annealing process that heat-treats the PET film 10 at about 150 for 90 minutes to shrink the film in advance.

The ITO film 20 is sequentially provided with a metal plating layer 40 to be used as an electrode and a metal deposition layer 30 for improving the adhesion of the metal plating layer 40. Before the metal deposition layer 30 and the metal plating layer 40 are formed on the ITO film 20, it is preferable to perform the pre-processing process of performing the impurities on the surface by using plasma or ion beams.

The metal deposition layer 30 includes a buffer layer to improve the adhesion between the ITO film 20 and the metal layer and a seed layer for plating a metal. The buffer layer improves the adhesion between the ITO film 20 and the metal layer. Therefore, the buffer layer may be formed by depositing a material such as Ni, Cr, Ni—Cr, Ti, Sn, Mo, or the like. Further, the seed layer is a layer deposited for forming the metal plating layer 40. The seed layer may use a material such as Ag, Cu, Au, and Al.

The metal plating layer 40 may be made of the same material as the seed layer of the metal deposition layer 30 and may be made of a material having excellent conductivity by using an electroplating method, or the like. The metal plating layer 40 may be operated as the electrode of the ITO film 20.

Since the metal deposition layer 30 and the metal plating layer 40 that are a metal layer in the touch screen having the above configuration directly affects the sensitivity of the touch screen, the thickness of the metal deposition layer 30 and the metal plating layer 40 may be controlled so that the resistance value may be controlled to be set to 0.1 Ω/square or less.

FIG. 2 is a cross-sectional view of a touch screen according to a second embodiment of the present invention. As shown in FIG. 2, the touch screen according to the second embodiment of the present invention includes a buffer layer 33 formed by depositing Ni—Cr on the ITO film 20 deposited on the PET film 10, a seed layer 35 formed by forming Cu, and a plated layer 45 formed by plating Cu.

The metal deposition layer 30 directly deposited on the ITO film 20 includes the buffer layer 33 and the seed layer 35 for plating in order to improve the adhesion between the ITO film 20 and the metal layer.

In order to control the resistance value to 0.1 Ω/square or less, the buffer layer 33 may be formed by depositing Ni—Cr at a thickness of 70 using a vacuum deposition technology. The seed layer 35 may be formed by depositing Cu at 900 using the vacuum deposition technology. Further, the electrode of the touch screen may be formed by depositing Cu on the metal plating layer at a thickness of 8000.

In this case, when depositing the Ni—Cr buffer layer 33 and the Cu seed layer 35, the surface of the ITO film 20 is pre-processed using the method such as the plasma processing, the ion beam irradiation, or the like and then, the metal layer is deposited, such that the damage to the surface of the ITO film 20 may be prevented and the adhesion and the conductivity of the metal layer may be improved.

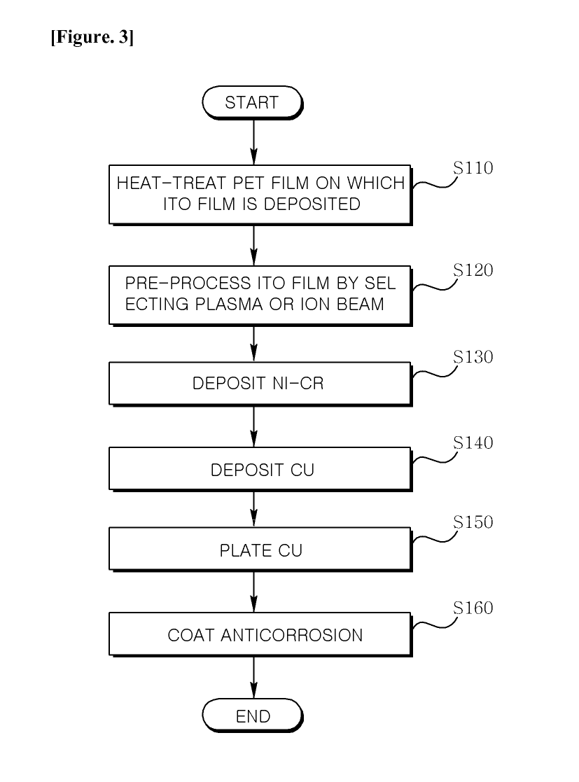

FIG. 3 is a flow chart of a method of manufacturing a touch screen according to an embodiment of the present invention.

As shown in FIG. 3, when the touch screen is manufactured according to the embodiment of the present invention, the PET film 10 on which the ITO film 20 is deposited is heat-treated (S110).

The surface of the ITO film 20 is pre-processed by using the plasma or the ion beams (S120) in order to improve the adhesion of the metal layer. In this case, reactive gas for generating ion beams may be selected among O₂, O₃, N₂, N₂O, NO₂, and CO₂ and may be selected among inert gases such as Ar, Kr, Xe, and Ne. In addition, the reactive gas or the inert gas may be applied alone or in a mixing state. Further, the irradiation amount of the ion beams may be used within a range of 1×10¹⁵/cm²˜1×10¹⁸/cm².

The metal deposition layer, the Ni—Cr buffer layer 33 that serves to as the buffer layer is deposited on the pre-processed ITO film 20 (S130). The Ni-Cr buffer layer 33 may be formed by being deposited by the vacuum deposition technology such as RF sputter, DC sputter, CVD, or the like.

The metal deposition layer, the Cu seed layer 35 that serves as the seed layer is deposited on the Ni-Cr buffer layer 33 (S140). The Cu seed layer 35 may be formed by being deposited by the vacuum deposition technology such as RF sputter, DC sputter, CVD, or the like.

When the Cu seed layer 35 is formed, the Cu plating layer 45 that serves as the electrode is plated (S150). The Cu plating layer 45 may be formed by using an electroplating method, or the like.

When the electrode of the touch screen is formed using the Cu plating layer 45, an anticorrosive coating is performed in order to prevent the Cu metal from being oxidized (S160). The anticorrosive coating may be subjected to the coating processing by dipping the Cu plating layer 45 in a corrosion inhibitor.

While the invention will be described in conjunction with exemplary embodiments, it will be understood that present description is not intended to limit the invention to those exemplary embodiments. It will be apparent to those skilled in the art that various modifications and variation can be made in the present invention without departing from the spirit or scope of the invention. Thus, it is intended that the present invention cover the modifications and variations of this invention, provided they come within the scope of the appended claims and their equivalents.

### INDUSTRIAL APPLICABILITY

The present invention can provide the touch screen with the excellent sensitivity while securing the durability.

1. A composition for laser direct structuring, comprising:
a base resin;
a seed forming agent; and
a laser absorbent.

2. The composition according to claim 1, wherein the composition is coated onto an upper side of a base frame, on which patterns will be formed by laser irradiation in laser direct structuring.

3. The composition according to claim 1, wherein the composition forms a base frame, on which patterns will be formed by laser irradiation in laser direct structuring.

4. The composition according to claim 2, comprising: 90 wt % to 98 wt % of the base resin; 0.1 wt % to 5 wt % of the seed forming agent; and 1.9 wt % to 5 wt % of the laser absorbent in terms of solid content.

5. The composition according to claim 3, comprising: 80 wt % to 95.4 wt % of the base resin; 0.1 wt % to 5 wt % of the seed forming agent; and 4.5 wt % to 15 wt % of the laser absorbent in terms of solid content.

6. The composition according to claim 1, wherein the base resin comprises at least one selected from the group consisting of urethane resins, acrylic resins, polypropylenes, polyamides, polyesters including polyethylene terephthalate (PET), polybutylene terephthalate (PBT) and the like, polybutylene terephthalate of a cross-linking structure, liquid crystal polymers, polycarbonates, polyphthalamides, and polyphenylene oxide.

7. The composition according to claim 1, wherein the seed forming agent comprises at least one selected from the group consisting of copper salts and complexing agents.

8. The composition according to claim 1, wherein the laser absorbent comprises a pigment comprising a heavy metal composite oxide or copper salt.

9. A laser direct structuring method comprising using the composition for laser direct structuring according claim 1.

10. A laser direct structuring method comprising using the composition for laser direct structuring according to claim 2.

11. A laser direct structuring method comprising using the composition for laser direct structuring according to claim 3.

12. A laser direct structuring method comprising using the composition for laser direct structuring according to claim 4.

13. A laser direct structuring method comprising using the composition for laser direct structuring according to claim 5.

14. A laser direct structuring method comprising using the composition for laser direct structuring according to claim 6.

15. A laser direct structuring method comprising using the composition for laser direct structuring according to claim 7.

16. A laser direct structuring method comprising using the composition for laser direct structuring according to claim 8.
